(19) United States
(12) Patent Application Publication
(10) Pub. No.: US 2026/0012590 A1
(43) Pub. Date: Jan. 8, 2026

(54) Low-Complexity Filtering Of Fixed-Filtered Data

(71) Applicant: GOOGLE LLC, Mountain View, CA (US)

(72) Inventors: Xiang Li, Saratoga, CA (US); Debargha Mukherjee, Cupertino, CA (US); Jingning Han, Santa Clara, CA (US); Yaowu Xu, Saratoga, CA (US)

(21) Appl. No.: 19/256,650

(22) Filed: Jul. 1, 2025

Related U.S. Application Data
(60) Provisional application No. 63/667,516, filed on Jul. 3, 2024.

(51) Int. Cl. H04N 19/117; H04N 19/176; H04N 19/186; H04N 19/46; H04N 19/82; H04N 19/91; H04N 19/96

(52) U.S. Cl. CPC H04N 19/117; H04N 19/176; H04N 19/186; H04N 19/46; H04N 19/82; H04N 19/91; H04N 19/96

(57) ABSTRACT

Decoding using low-complexity filtering of fixed-filtered data includes obtaining reconstructed block data for a current block of a current frame by decoding encoded block data from an encoded bitstream, obtaining filtered reconstructed block data for the current block, and outputting the filtered reconstructed block data. Obtaining the filtered reconstructed block data includes obtaining a first filter for the current block, wherein obtaining the first filter omits accessing parameter data for the first filter from a portion of the encoded bitstream corresponding to the current frame, obtaining first filtered reconstructed block data for the current block by filtering the reconstructed block data using the first filter, accessing, from the portion of the encoded bitstream corresponding to the current frame, low-complexity filtering data for a low-complexity filter, and obtaining second filtered reconstructed block data for the current block by filtering the first filtered reconstructed block data using the low-complexity filter.

### CROSS-REFERENCE TO RELATED APPLICATION(S)

This application claims priority to and the benefit of U.S. Provisional Application Patent Ser. No. 63/667,516, filed Jul. 3, 2024, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using low-complexity filtering of fixed-filtered data.

Variations in these and other aspects will be described in additional detail hereafter.

An aspect is a method for encoding using low-complexity filtering of fixed-filtered data. Encoding using low-complexity filtering of fixed-filtered data may include obtaining reconstructed block data for a current block of a current frame by decoding encoded block data from an encoded bitstream, obtaining filtered reconstructed block data for the current block, and outputting the filtered reconstructed block data. Obtaining the filtered reconstructed block data may include obtaining a first filter for the current block, wherein obtaining the first filter omits accessing parameter data for the first filter from a portion of the encoded bitstream corresponding to the current frame, obtaining first filtered reconstructed block data for the current block by filtering the reconstructed block data using the first filter, accessing, from the portion of the encoded bitstream corresponding to the current frame, low-complexity filtering data for a low-complexity filter, and obtaining second filtered reconstructed block data for the current block by filtering the first filtered reconstructed block data using the low-complexity filter.

An aspect is a non-transitory computer-readable storage medium, having stored thereon an encoded bitstream comprising encoded block data for a current block of a current frame and low-complexity filtering data for a low-complexity filter for filtering filtered reconstructed block data for the current block, wherein the filtered reconstructed block data corresponds to filtering, using a first filter, reconstructed block data for the current block, wherein the reconstructed block data corresponds to decoding the encoded block data, wherein parameter data for the first filter is absent from a portion of the encoded bitstream corresponding to the current frame.

An aspect is a method for decoding using low-complexity filtering of fixed-filtered data. Decoding using low-complexity filtering of fixed-filtered data may include obtaining an encoded bitstream and outputting the encoded bitstream. Obtaining the encoded bitstream may include including encoded block data for a current block of a current frame in the encoded bitstream, obtaining reconstructed block data for the current block, and obtaining filtered reconstructed block data for the current block. Obtaining the filtered reconstructed block data may include obtaining first filtered reconstructed block data for the current block by filtering the reconstructed block data using a first filter, wherein obtaining the encoded bitstream omits including parameter data for the first filter in a portion of the encoded bitstream corresponding to the current frame, obtaining low-complexity filtering data for a low-complexity filter, including, in the portion of the encoded bitstream corresponding to the current frame, the low-complexity filtering data, and obtaining second filtered reconstructed block data for the current block by filtering the first filtered reconstructed block data using the low-complexity filter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flow diagram of an example of encoding using low-complexity filtering of fixed-filtered data in accordance with implementations of this disclosure.

FIG. 8 is a flowchart diagram of an example of obtaining filtered reconstructed block data for encoding.

FIG. 9 is a flowchart diagram of an example of decoding using low-complexity filtering of fixed-filtered data in accordance with implementations of this disclosure.

FIG. 10 is a flowchart diagram of an example of obtaining filtered reconstructed block data for decoding.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Block-based hybrid video coding techniques, or codecs, to improve coding efficiency, but may introduce coding artifacts. Loop filtering may be performed to minimize the quality loss corresponding to coding artifacts. Loop filtering may include filtering using fixed, or offline trained, filters, wherein parameters of a fixed filter used for filtering a portion of a current frame are absent from the portion of the encoded bitstream corresponding to the current frame. However, fixed filters may have sub-optimal efficiency. Loop filtering may include filtering using filters adapted for the current frame, wherein parameters of the adapted filters are signaled in the portion of the encoded bitstream corresponding to the current frame. However, the resource utilization, or bit cost, for signaling the parameters of adaptive filters is relatively high, such as for low-rate video coding.

The encoding and decoding using low-complexity filtering of fixed-filtered data described herein improves on video coding techniques, or codecs, by signaling parameters for a low-complexity filter to be applied to data previously filtered using a fixed filter. Signaling the parameters of the low-complexity filter has relatively low resource utilization, or bit cost, such as relative to signaling the parameters of an adaptive filter. Filtering the data previously filtered using a fixed filter improves the accuracy of the filtered data. The encoding and decoding using low-complexity filtering of fixed-filtered data described herein avoid filtering data previously filtered using an adaptive filter to avoid redundancy with the adaptation of the adaptive filter. Subsequent to filtering the data using the low-complexity filter, the filtered data may be further filtered, such as using an adaptive filter to further reduce coding artifacts.

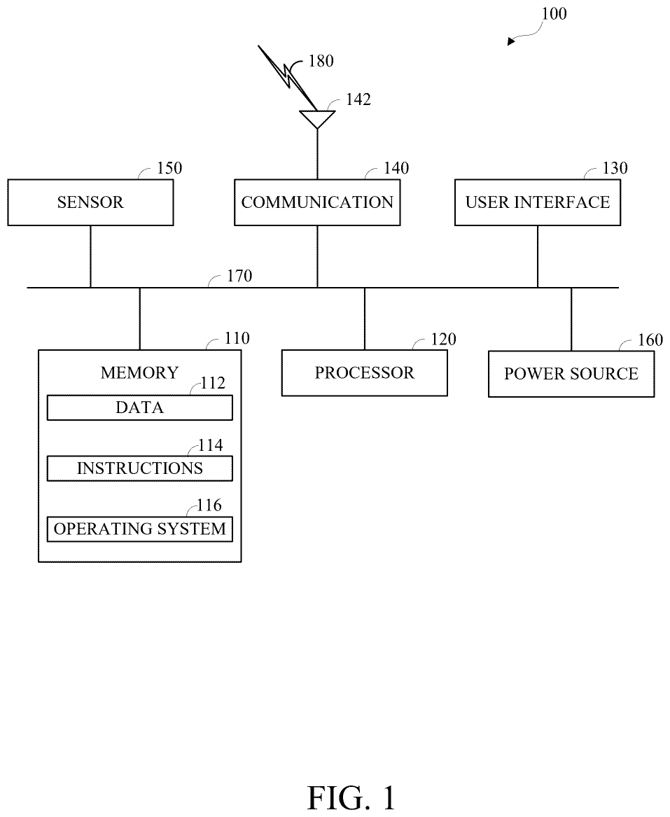

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

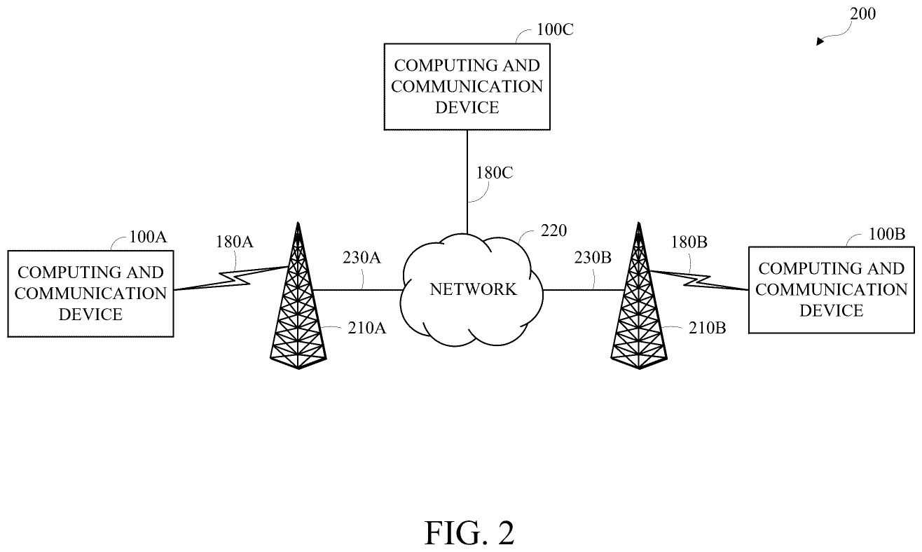

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

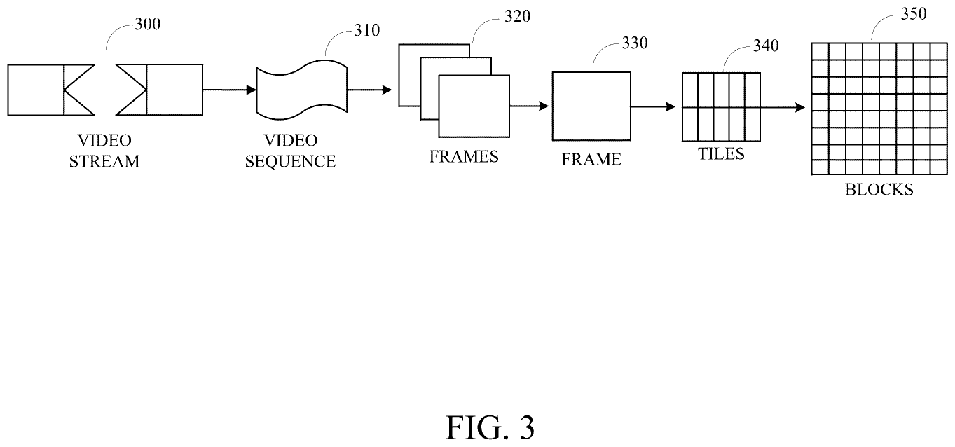

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

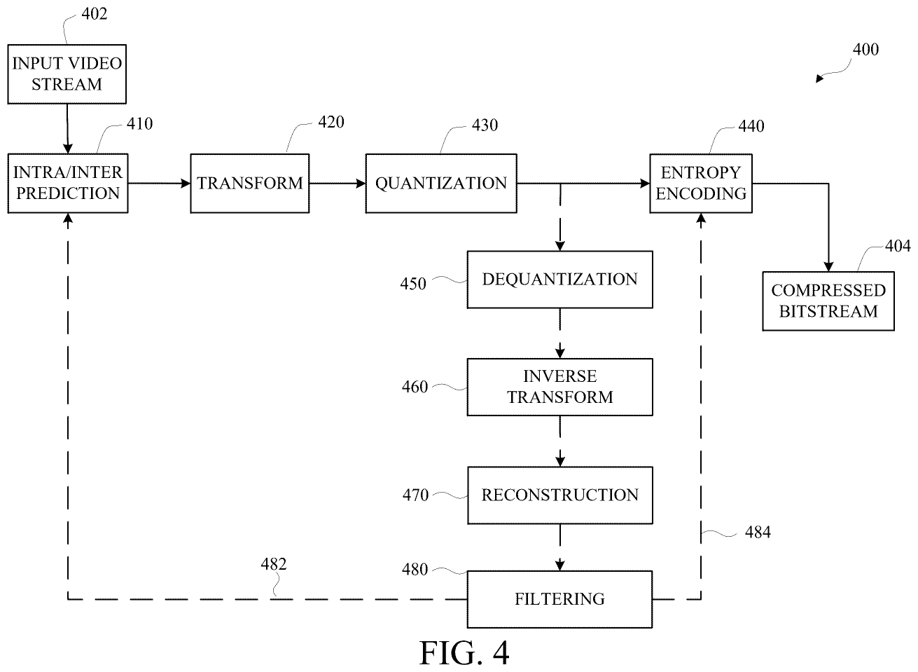

FIG. 4 is a block diagram of an encoder 400 in accordance with implementations of this disclosure. The encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

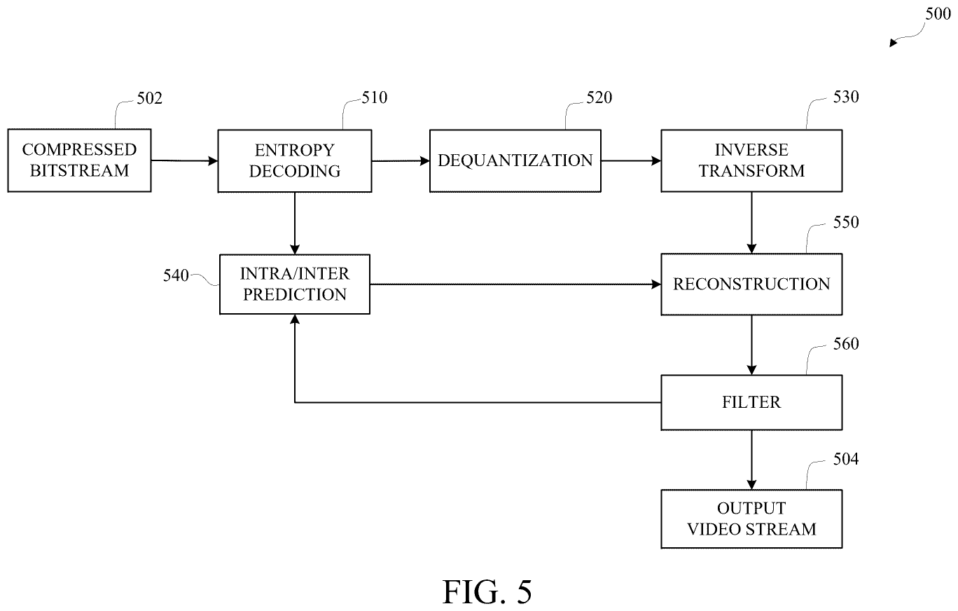

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 560.

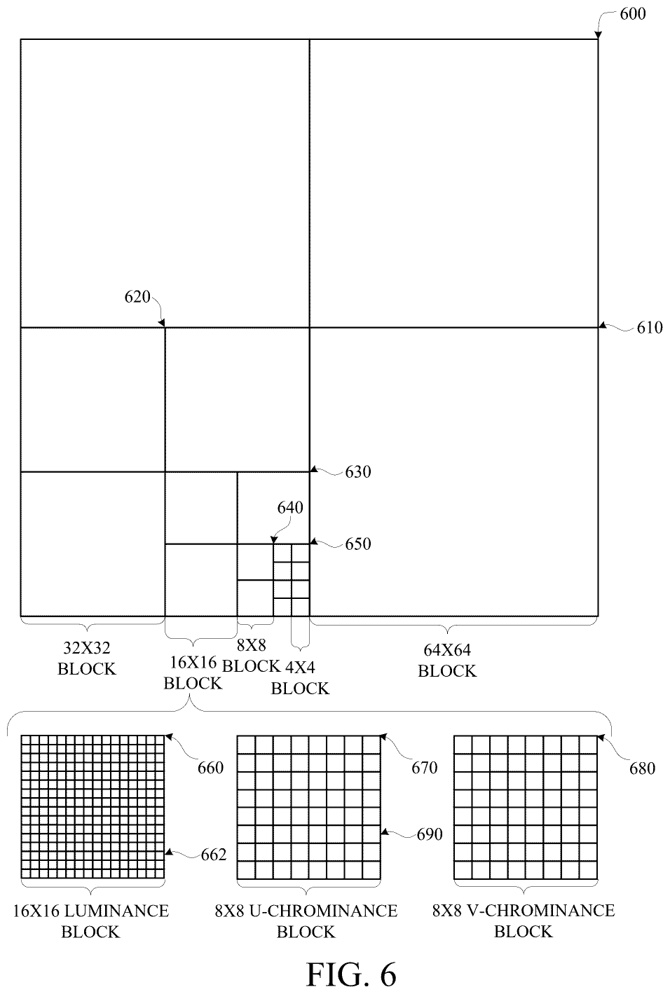

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x,y}. Similarly, a pixel of the search area of the reference frame may be indicated based on location using Cartesian coordinates as r_{x,y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

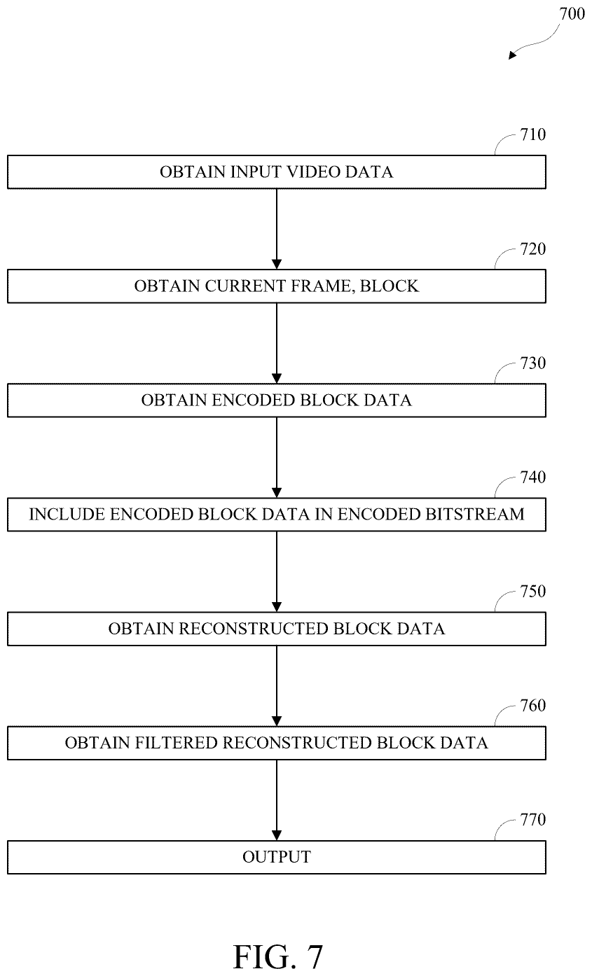

FIG. 7 is a flow diagram of an example of encoding using low-complexity filtering of fixed-filtered data 700 in accordance with implementations of this disclosure. Encoding using low-complexity filtering of fixed-filtered data 700 may be implemented by an encoder, such as the encoder 400 shown in FIG. 4.

Encoding using low-complexity filtering of fixed-filtered data 700 includes obtaining an encoded bitstream, or a portion or portions thereof, by encoding an input video steam, such as the input video stream 402 shown in FIG. 4, or one or more portions thereof, to generate an encoded (compressed) output bitstream, such as the encoded (compressed) bitstream 404 shown in FIG. 4.

In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data.

Encoding using low-complexity filtering of fixed-filtered data 700 includes obtaining the encoded bitstream, wherein obtaining the encoded bitstream includes obtaining input video data (at 710), obtaining a current frame and a current block (at 720), obtaining encoded block data (at 730), including the encoded block data in the encoded bitstream (at 740), obtaining reconstructed block data (at 750), obtaining filtered reconstructed block data (at 760), and outputting (at 770). Although not shown expressly in FIG. 7, encoding using low-complexity filtering of fixed-filtered data 700 includes other aspects of video coding.

The input video data is obtained (at 710). The input video data includes a sequence of frames (input frames). The input video data may be similar to the input video stream 402 shown in FIG. 4, except as is described herein or as is otherwise clear from context. For example, the encoder, or a component thereof, such as an intra/inter prediction unit of the encoder, such as the intra/inter prediction unit 410 shown in FIG. 4, may obtain the input video stream.

The current frame for encoding is obtained (at 720) from the sequence of frames from the input video data. The current frame may be obtained (at 720) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

The current block for encoding is obtained (at 720) from the current frame. The current block may be obtained (at 720) subsequent to encoding one or more other blocks, such as a block sequentially preceding the current block in the current frame, in accordance with a block coding order for coding the current frame, and generating, or otherwise obtaining, a corresponding reconstructed block, or one or more portions thereof.

The encoded block data is obtained (at 730). For example, to obtain the encoded block data the encoder obtains predicted block data for the current block, subtracts the predicted block data from the current block to obtain residual data, transforms the residual data to obtain transform block data for the current block, quantizes the transform block data to obtain quantized transform block data for the current block, entropy codes the quantized transform block data, and includes the entropy coded quantized transform block data in the encoded block data. Obtaining the encoded block data may include other aspects of encoding not expressly shown in FIG. 7. For example, obtaining the encoded block data may include obtaining prediction mode data for the current block, obtaining motion mode data for the current block, obtaining motion data, such as one or more motion vectors, for the current block, or a combination thereof, and including the prediction mode data, the motion mode data, the motion data, or a combination thereof in the encoded block data. In another example, encoding the current block may include prediction coding, such as the prediction coding shown at 410 in FIG. 4, transformation, such as the transformation shown at 420 in FIG. 4, quantization, such as the quantization shown at 420 in FIG. 4, and entropy coding, such as the entropy coding shown at 440 in FIG. 4, except as is described herein or as is otherwise clear from context.

The encoded block data is included in the encoded bitstream (at 740). For example, the encoder includes the encoded block data for the current block of the current frame in the encoded bitstream (at 740). The encoded bitstream may be similar to the compressed bitstream 404 shown in FIG. 4, except as is described herein or as is otherwise clear from context.

Reconstructed block data is obtained (at 750). Obtaining the reconstructed block data may include dequantization, such as the dequantization shown at 450 in FIG. 4, inverse transformation, such as the inverse transformation shown at 460 in FIG. 4, reconstruction, such as the reconstruction shown at 470 in FIG. 4, except as is described herein or as is otherwise clear from context.

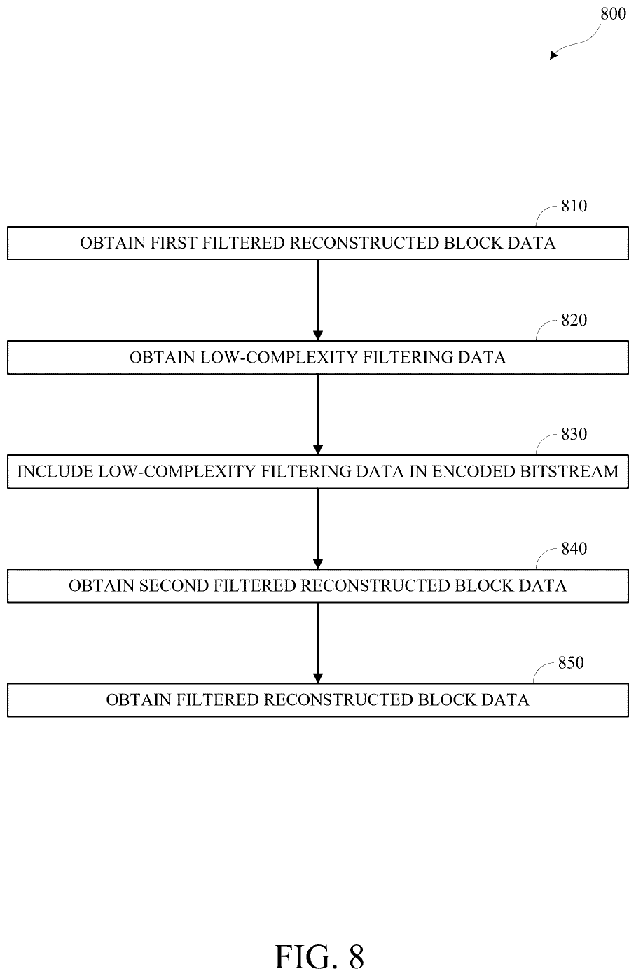

Filtered reconstructed block data is obtained (at 760). An example of obtaining filtered reconstructed block data is shown in FIG. 8.

The output, compressed, or encoded, bitstream, is output, such as stored or transmitted, such as to a decoder, (at 770). The filtered reconstructed block data is output to, such as stored in, a decoded picture buffer, or other data structure, (at 770) for subsequent use as reference frame data for encoding subsequent frames or for encoding subsequent portions of the current frame.

FIG. 8 is a flowchart diagram of an example of obtaining filtered reconstructed block data 800 for encoding. Obtaining filtered reconstructed block data 800 may be implemented by an encoder, such as the encoder 400 shown in FIG. 4. Obtaining filtered reconstructed block data 800 may be similar to the filtering shown at 480 in FIG. 4, except as is described herein or as is otherwise clear from context.

Obtaining filtered reconstructed block data 800 includes obtaining first filtered reconstructed block data (at 810), obtaining low-complexity filtering data (at 820), including the low-complexity filtering data in the encoded bitstream (at 830), obtaining second filtered reconstructed block data (at 840), and obtaining the filtered reconstructed block data (at 850).

The first filtered reconstructed block data is obtained (at 810) by filtering previously, such as prior to obtaining filtered reconstructed block data 800, obtained reconstructed block data, such as the reconstructed block data obtained as shown (at 750) in FIG. 7 using a first filter.

In some implementations, the reconstructed block data may be unfiltered reconstructed block data. In some implementations, the reconstructed block data may be previously obtained reconstructed block data, such as the reconstructed block data obtained as shown (at 750) in FIG. 7, filtered using adaptive filtering, such as deblocking filtering or luma mapping with chroma scaling filtering, or a portion or portions thereof, prior to obtaining the first filtered reconstructed block data (at 810). In implementations that include adaptive filtering prior to obtaining the first filtered reconstructed block data (at 810), one or more parameters of the adaptive filter, or respective parameters of respective adaptive filters, are included, or signaled, in the encoded bitstream, such as in the portion of the encoded bitstream corresponding to the current frame.

The first filter is a loop filter, or in-loop filter. A loop filter, or in-loop filter, is a filter that is used, or applied, at least in part, to a block, or a portion or portions thereof, subsequent to obtaining reconstructed block data for the block, or a portion or portions thereof, such as shown (at 750) in FIG. 7, and prior to storing, such as in a decoded picture buffer, filtered reconstructed block data for the current block for use in subsequent encoding of another block of the current frame or another frame.

The encoder omits, skips, avoids, or excludes including parameter data for the first filter in a portion of the encoded bitstream corresponding to the current frame.

In some implementations, the parameters of the first filter may be signaled, or otherwise included, in a portion of the encoded bitstream corresponding to a frame other than the current frame.

The low-complexity filtering data is obtained (at 820) for a low-complexity filter.

In some implementations, the low-complexity filter is a scaling filter (low-complexity scaling filter), wherein a respective sample (x) is multiplied by a corresponding scaling factor (a), to obtain a filtered sample value (x′), which may be expressed as x′=ax. The low-complexity scaling filter may have a shape of 1×1. Filtering using the low-complexity scaling filter may omit operations other than scaling. In implementations wherein the low-complexity filter is a low-complexity scaling filter, obtaining the low-complexity filtering data includes obtaining low-complexity filtering scaling factor data indicating the scaling factor.

In some implementations, obtaining the scaling factor includes obtaining a low-complexity filtering scaling factor index value that indicates a non-uniform quantization of the low-complexity filtering scaling factor. For example, a low-complexity filtering scaling factor index value of zero (0) may indicate a low-complexity filtering scaling factor of 2/8, a low-complexity filtering scaling factor index value of one (1) may indicate a low-complexity filtering scaling factor of 4/8, a low-complexity filtering scaling factor index value of two (2) may indicate a low-complexity filtering scaling factor of 6/8, and a low-complexity filtering scaling factor index value of three (3) may indicate a low-complexity filtering scaling factor of 7/8.

In some implementations, the low-complexity filter is a linear filter (low-complexity linear filter), wherein a respective sample (x) is multiplied by a corresponding scaling factor (a) and combined, such as by addition, with a corresponding offset value (b), to obtain a filtered sample value (x′), which may be expressed as x′=ax+b. Filtering using the low-complexity linear filter may omit non-linear operations, such as clipping. In implementations wherein the low-complexity filter is a low-complexity linear filter, obtaining the low-complexity filtering data includes obtaining low-complexity filtering scaling factor data indicating the scaling factor and obtaining low-complexity filtering offset data indicating the offset value.

In some implementations, the low-complexity filter is a combination of a linear filter and a non-linear operation, wherein a respective sample (x) is multiplied by a corresponding scaling factor (a) and combined, such as by addition, with a corresponding offset value (b), to obtain an unconstrained filtered sample value, and the unconstrained filtered sample value is clipped, or constrained, using the non-linear operation to be within a defined range, such as a from a minimum value (inclusive) to a maximum value (inclusive).

In implementations wherein the low-complexity filter includes the combination of the linear filter and the non-linear operation, obtaining the low-complexity filtering data includes obtaining low-complexity filtering scaling factor data indicating the scaling factor, obtaining low-complexity filtering offset data indicating the offset value, obtaining low-complexity filtering clipping minimum data indicating the minimum value of the range, and obtaining low-complexity filtering clipping maximum data indicating the maximum value of the range.

In some implementations, the scaling factor may be obtained, or derived, by error minimization, such as by minimizing least square distortion or by minimizing mean squared error. In some implementations, the scaling factor may be obtained from one or more previously, such as prior to encoding the current video, defined sets of scaling factors by identifying the previously defined scaling factors corresponding to minimizing rate-distortion cost.

In some implementations, the scaling factor may be zero and obtaining filtered reconstructed block data 800 may be otherwise skipped, omitted, or excluded.

The low-complexity filtering data is included in the encoded bitstream (at 830).

In some implementations, including the low-complexity filtering data in the encoded bitstream includes including the low-complexity filtering data in frame level data for the current frame.

In some implementations, including the low-complexity filtering data in the encoded bitstream includes including the low-complexity filtering data in slice level data for a slice of the current frame, such as a slice that includes the current block. In some implementations, the low-complexity filtering data may be included in in slice level data for a slice of the current frame other than the slice that includes the current block.

In some implementations, including the low-complexity filtering data in the encoded bitstream includes including the low-complexity filtering data in tile level data for a tile of the current frame, such as a tile that includes the current block. In some implementations, the low-complexity filtering data may be included in in tile level data for a tile of the current frame other than the tile that includes the current block.

In some implementations, including the low-complexity filtering data in the encoded bitstream includes including the low-complexity filtering data in group-of-blocks level data, or superblock data, such as for a group of blocks, or a superblock, which includes the current block.

In some implementations, including the low-complexity filtering data in the encoded bitstream includes including the low-complexity filtering data in block level data or coding tree unit level data.

In some implementations, including the low-complexity filtering data in the encoded bitstream includes including the low-complexity filtering data in coding tree block level data or data for a component, such as a luma component or a chroma component, of the current block.

Including the low-complexity filtering data in the encoded bitstream (at 830) includes including one or more of the low-complexity filtering scaling factor data, the low-complexity filtering offset data, the low-complexity filtering clipping minimum data, or the low-complexity filtering clipping maximum data in the encoded bitstream.

In some implementations, the low-complexity filter is the low-complexity scaling filter and including the low-complexity filtering data in the encoded bitstream includes including the low-complexity filtering scaling factor data, such as a low-complexity filtering scaling factor index value, indicating the scaling factor in the low-complexity filtering data in the encoded bitstream.

In some implementations, the low-complexity filter is the low-complexity linear filter and including the low-complexity filtering data in the encoded bitstream includes including the low-complexity filtering scaling factor data, such as a low-complexity filtering scaling factor index value, indicating the scaling factor in the low-complexity filtering data in the encoded bitstream and including the low-complexity filtering offset data indicating the offset value in the low-complexity filtering data in the encoded bitstream.

In some implementations, the low-complexity filter is a combination of the low-complexity linear filter and a non-linear operation and including the low-complexity filtering data in the encoded bitstream includes including the low-complexity filtering scaling factor data, such as the low-complexity filtering scaling factor index value, indicating the scaling factor in the low-complexity filtering data in the encoded bitstream, including the low-complexity filtering offset data indicating the offset value in the low-complexity filtering data in the encoded bitstream, including the low-complexity filtering clipping minimum data indicating the minimum value of the range in the low-complexity filtering data in the encoded bitstream, and including the low-complexity filtering clipping maximum data indicating the maximum value of the range in the low-complexity filtering data in the encoded bitstream.

In some implementations, including the low-complexity filtering data in the encoded bitstream includes including, in coding tree block level data for a current luma coding tree block of the current block, low-complexity filtering flag data for the current luma coding tree block indicating whether low-complexity filtering is enabled, or disabled, for the current luma coding tree block.

In some implementations, including the low-complexity filtering flag data for the current luma coding tree block in the coding tree block level data for the current luma coding tree block includes entropy coding the low-complexity filtering flag data using an entropy coding context obtained in accordance with low-complexity filtering flag data for a luma coding tree block above the current luma coding tree block, low-complexity filtering flag data for a luma coding tree block to the left of the current luma coding tree block, or a combination of the low-complexity filtering flag data for the luma coding tree block above the current luma coding tree block and the low-complexity filtering flag data for the luma coding tree block to the left of the current luma coding tree block.

In some implementations, the low-complexity filtering flag data for the current luma coding tree block indicates that low-complexity filtering is enabled for the current luma coding tree block, and including the low-complexity filtering data in the encoded bitstream includes including the low-complexity filtering scaling factor data for the current luma coding tree block in the encoded bitstream.

In some implementations, including the low-complexity filtering scaling factor data for the current luma coding tree block in the encoded bitstream includes including the low-complexity filtering scaling factor data in the encoded bitstream using fixed length coding, truncated unary coding, or truncated binary coding.

The second filtered reconstructed block data is obtained (at 840) by filtering the first filtered reconstructed block data using the low-complexity filter.

In some implementations, obtaining the first filtered reconstructed block data (at 810) includes sample adaptive offset (SAO) filtering the reconstructed block data to obtain sample adaptive offset filtered reconstructed block data and obtaining the first filtered reconstructed block data by filtering the sample adaptive offset filtered reconstructed block data using the first filter.

Sample adaptive offset filtering is adaptive filtering that includes classifying samples of a region, such as coding tree unit, into respective groups and applying offsets to the respective samples on a per-group basis. Sample adaptive offset filtering parameters, such as per-component parameters, are adapted on a per-region basis. Sample adaptive offset filtering may include edge offset (EO) filtering, band offset (BO) filtering, or both. Edge offset filtering includes classifying samples based on comparison between current samples and neighboring samples. Band offset filtering includes classifying samples based on based on sample values. The sample adaptive offset filtering parameters are signaled, or included in the encoded bitstream, at the coding tree block level for the current block. Obtaining filtered reconstructed block data 800 omits, skips, avoids, or excludes filtering the sample adaptive offset filtered reconstructed block data using the low-complexity filter prior to filtering the sample adaptive offset filtered reconstructed block data using the first filter.

In some implementations, the first filter is a component of adaptive loop filtering (ALF). Adaptive loop filtering may be used, or applied, to filter the sample adaptive offset filtered reconstructed block data.

Adaptive loop filtering may include using a 7×7 diamond shape filter and a 5×5 diamond shape filter for the luma component, or luma coding tree block, of the current block and the chroma components, or chroma coding tree blocks, of the current block, respectively.

Adaptive loop filtering may include sub-block level filter adaptation for the luma component, wherein a respective 4×4 luma sub-block is classified, such as into a defined set of classes, such as twenty-five classes, based on the directionality of the respective sub-block and two-dimensional Laplacian activity. Per-class filter parameters may be signaled, such as included in the encoded bitstream.

Adaptive loop filtering may include coding tree block level filter adaptation. A luma coding tree block may be filtered using parameters obtained from a filter set for the current slice that includes the current block, or using parameters obtained from a filter set for another slice of the current frame. A luma coding tree block may be filtered using a fixed, or offline trained, filter set, from defined available filter sets, such as sixteen defined available fixed, or offline trained, filter sets, wherein parameters of the fixed, or offline trained, filters are omitted, excluded, or otherwise absent, from the encoded bitstream, or from the portion of the encoded bitstream corresponding to the current frame. For a respective luma coding tree block, the filter from the selected filter set for filtering a respective 4×4 block is determined by the class for the block. A chroma coding tree block may be filtered using parameters obtained from a filter set for the current slice that includes the current block.

In some implementations, adaptive loop filtering may include identifying, or selecting, a defined filter set, such as from multiple, such as eight, available defined filter sets, for a luma coding tree block, wherein a respective filter set may include multiple, such as 512, fixed filters. For a 2×2 luma subblock, a fixed filter may be identified, or selected, from the identified, or selected, filter set in accordance with classification data for the 2×2 luma subblock. The filter set may be signaled using an index value in accordance with a quantization parameter for the coding tree block.

In some implementations, the first filter is an artificial neural network filter, or artificial neural network loop filter, trained on training data that omits, skips, avoids, or excludes the current frame (offline trained). In some implementations, parameter data for the artificial neural network filter is omitted, absent, or unavailable from the portion of the encoded bitstream corresponding to the current frame. In some implementations, filtering using the artificial neural network filter, or artificial neural network loop filter, as the first filter is omitted, skipped, avoided, or excluded.

The filtered reconstructed block data is obtained (at 850).

In some implementations, obtaining the filtered reconstructed block data (at 850) includes using the second filtered reconstructed block data (obtained at 840) as the filtered reconstructed block data.

In an example, the reconstructed block data is filtered using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain the first filtered reconstructed block data (at 810), wherein the adaptive loop filtering omits filtering using an adaptive filter. The first filtered reconstructed block data is filtered using the low-complexity filter to obtain the second filtered reconstructed block data (at 840). The second filtered reconstructed block data is used as the filtered reconstructed block data (at 850).

In some implementations, obtaining the filtered reconstructed block data (at 850) includes filtering the second filtered reconstructed block data (obtained at 840) to obtain the filtered reconstructed block data.

In an example, the reconstructed block data is filtered using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain the first filtered reconstructed block data (at 810). The first filtered reconstructed block data is filtered using the low-complexity filter to obtain the second filtered reconstructed block data (at 840). The second filtered reconstructed block data is filtered (at 850) using an adaptive filter of adaptive loop filtering wherein parameters of the adaptive filter are signaled, or included, in the encoded bitstream, or in the portion of the encoded bitstream corresponding to the current frame, to obtain the filtered reconstructed block data.

In an example, the reconstructed block data is filtered using an artificial neural network loop filter, trained on training data that omits, skips, avoids, or excludes the current frame (offline trained), wherein parameters of the artificial neural network loop filter are omitted, excluded, or otherwise absent, from the encoded bitstream, or from the portion of the encoded bitstream corresponding to the current frame, to obtain the first filtered reconstructed block data (at 810). The first filtered reconstructed block data is filtered using the low-complexity filter to obtain the second filtered reconstructed block data (at 840). The second filtered reconstructed block data is filtered (at 850) using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using an adaptive filter wherein parameters of the adaptive filter are signaled, or included, in the encoded bitstream, or in the portion of the encoded bitstream corresponding to the current frame, to obtain the filtered reconstructed block data.

In an example, the reconstructed block data is filtered using an artificial neural network loop filter, trained on training data that omits, skips, avoids, or excludes the current frame (offline trained), wherein parameters of the artificial neural network loop filter are omitted, excluded, or otherwise absent, from the encoded bitstream, or from the portion of the encoded bitstream corresponding to the current frame, to obtain the first filtered reconstructed block data (at 810). The first filtered reconstructed block data is filtered using the low-complexity filter to obtain the second filtered reconstructed block data (at 840). The second filtered reconstructed block data is filtered (at 850) using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain third filtered reconstructed block data. The third filtered reconstructed block data is filtered using an adaptive filter of adaptive loop filtering wherein parameters of the adaptive filter are signaled, or included, in the encoded bitstream, or in the portion of the encoded bitstream corresponding to the current frame, to obtain the filtered reconstructed block data.

In an example, the reconstructed block data is filtered using an artificial neural network loop filter, trained on training data that omits, skips, avoids, or excludes the current frame (offline trained), wherein parameters of the artificial neural network loop filter are omitted, excluded, or otherwise absent, from the encoded bitstream, or from the portion of the encoded bitstream corresponding to the current frame, to obtain the first filtered reconstructed block data (at 810). The first filtered reconstructed block data is filtered using the low-complexity filter to obtain the second filtered reconstructed block data (at 840). The second filtered reconstructed block data is filtered (at 850) using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain third filtered reconstructed block data. The third filtered reconstructed block data is filtered using the low-complexity filter to obtain fourth filtered reconstructed block data (at 840). The fourth filtered reconstructed block data is filtered (at 850) using an adaptive filter of adaptive loop filtering wherein parameters of the adaptive filter are signaled, or included, in the encoded bitstream, or in the portion of the encoded bitstream corresponding to the current frame, to obtain the filtered reconstructed block data.

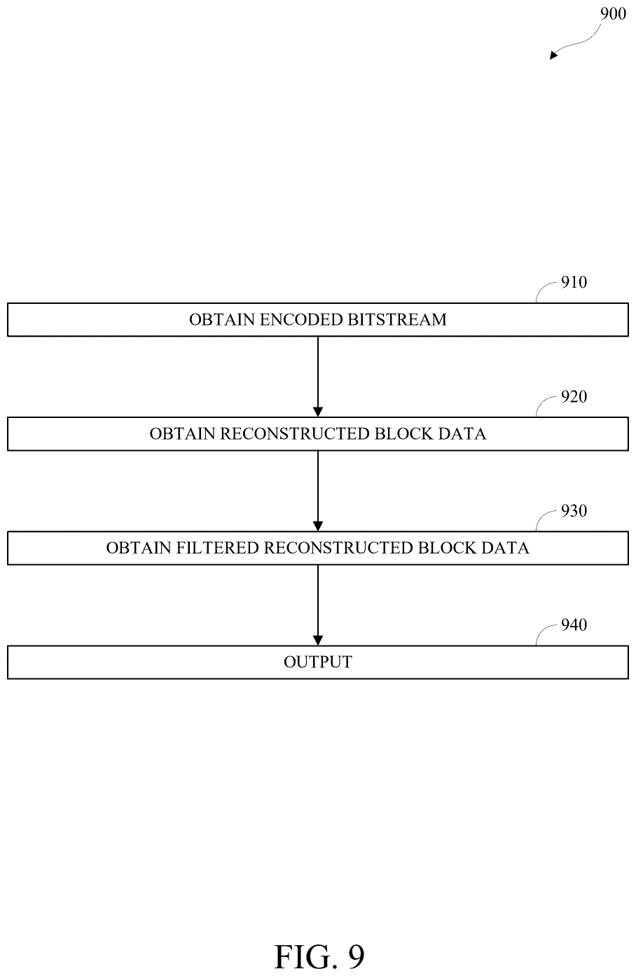

FIG. 9 is a flowchart diagram of an example of decoding using low-complexity filtering of fixed-filtered data 900 in accordance with implementations of this disclosure. Decoding using low-complexity filtering of fixed-filtered data 900 may be implemented in a decoder, such as the decoder 500 shown in FIG. 5. Decoding using low-complexity filtering of fixed-filtered data 900 includes block-based hybrid video coding as described herein.

Decoding using low-complexity filtering of fixed-filtered data 900 includes generating reconstructed video data by decoding an encoded bitstream, such as the compressed bitstream 502 shown in FIG. 5, or one or more portions thereof, to generate a reconstructed video, or a portion thereof, such as the output video stream 504 shown in FIG. 5.

Decoding the encoded bitstream, or one or more portions thereof, for decoding using low-complexity filtering of fixed-filtered data 900, includes obtaining the encoded bitstream (at 910), obtaining reconstructed block data (at 920), obtaining filtered reconstructed block data (at 930), and outputting reconstructed frame data (at 940). One or more aspects of decoding using low-complexity filtering of fixed-filtered data 900 may be omitted from the description herein for simplicity and brevity.

The encoded bitstream is obtained (at 910). For example, the decoder, or a component thereof, such as an intra/inter prediction unit of the decoder, such as the entropy decoding unit 510 shown in FIG. 5, may obtain the encoded bitstream. Obtaining the encoded bitstream includes identifying a current frame from a current sequence of frames to decode from the encoded bitstream to generate a current reconstructed frame. Obtaining the encoded bitstream includes identifying a current block from the current frame to decode from the encoded bitstream to generate a current reconstructed block (reconstructed block data).

The reconstructed block data is obtained (at 920) by decoding encoded block data from the encoded bitstream. For example, obtaining the reconstructed block data (at 920) may include entropy decoding, such as the entropy decoding shown (at 510) in FIG. 5, dequantization, such as the dequantization shown (at 520) in FIG. 5, inverse transformation, such as the inverse transformation shown (at 530) in FIG. 5, prediction, such as intra prediction, inter prediction, or a combination thereof, as shown (at 540) in FIG. 5, and reconstruction, such as the reconstruction shown (at 550) in FIG. 5.

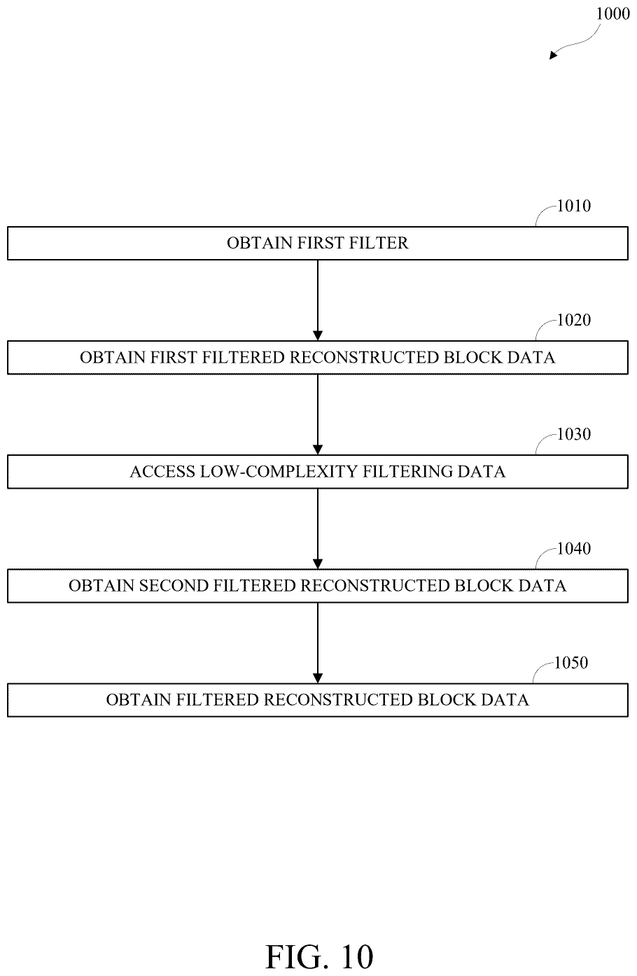

The filtered reconstructed block data is obtained (at 930). An example of obtaining filtered reconstructed block data is shown in FIG. 10.

The decoder outputs the reconstructed frame data (at 940). Outputting the reconstructed frame data includes including the filtered reconstructed block data (obtained at 930) in the reconstructed frame data. Outputting the reconstructed frame data may include outputting the reconstructed frame data for display or presentation. Outputting the reconstructed frame data may include storing the reconstructed frame data in a decoded picture buffer or other data store for use as a reference frame for decoding another frame, or one or more portions thereof.

FIG. 10 is a flowchart diagram of an example of obtaining filtered reconstructed block data 1000 for decoding. Obtaining filtered reconstructed block data 1000 may be implemented in a decoder, such as the decoder 500 shown in FIG. 5. Obtaining filtered reconstructed block data 1000 may be similar to the filtering shown at 560 in FIG. 5, except as is described herein or as is otherwise clear from context.

Obtaining filtered reconstructed block data 1000 includes obtaining a first filter (at 1010), obtaining first filtered reconstructed block data (at 1020), accessing low-complexity filtering data (at 1030), obtaining second filtered reconstructed block data (at 1040), and obtaining the filtered reconstructed block data (at 1050).

The first filter is obtained (at 1010). The first filter is a loop filter, or in-loop filter. In some implementations, obtaining the first filter includes accessing, from the encoded bitstream, or from a portion of the encoded bitstream corresponding to the current frame, an index value that identifies the first filter. Obtaining the first filter omits, skips, avoids, or excludes accessing parameter data for the first filter from a portion of the encoded bitstream corresponding to the current frame. The first filter is a fixed, or offline trained, filter wherein parameter data for the first filter is absent, or otherwise unavailable, from the portion of the encoded bitstream corresponding to the current frame. For example, the first filter may be an artificial neural network filter trained on data other than the current frame. In another example, the first filter may be a fixed filter component of an adaptive loop filter. In some implementations, the parameter data for the first filter may be included in a portion of the encoded bitstream corresponding to a frame other than the current frame, or another portion of the encoded bitstream, other than the portion of the encoded bitstream corresponding to the current frame.

The decoder omits, skips, avoids, or excludes accessing, reading, extracting, decoding, or otherwise obtaining parameter data for the first filter from a portion of the encoded bitstream corresponding to the current frame.

The first filtered reconstructed block data is obtained (at 1020) by filtering previously, such as prior to obtaining filtered reconstructed block data 1000, obtained reconstructed block data, such as the reconstructed block data obtained as shown (at 920) in FIG. 9, using the first filter.

In some implementations, the reconstructed block data may be unfiltered reconstructed block data. In some implementations, the reconstructed block data may be previously obtained reconstructed block data, such as the reconstructed block data obtained as shown (at 920) in FIG. 9, filtered using adaptive filtering, such as deblocking filtering or luma mapping with chroma scaling filtering, or a portion or portions thereof, prior to obtaining the first filtered reconstructed block data (at 1020). In implementations that include adaptive filtering prior to obtaining the first filtered reconstructed block data (at 1020), one or more parameters of the adaptive filter, or respective parameters of respective adaptive filters, are included, or signaled, in the encoded bitstream, such as in the portion of the encoded bitstream corresponding to the current frame.

The low-complexity filtering data is accessed from the encoded bitstream (at 1030) for a low-complexity filter.

In some implementations, the low-complexity filter is a scaling filter (low-complexity scaling filter), wherein a respective sample (x) is multiplied by a corresponding scaling factor (a), to obtain a filtered sample value (x′), which may be expressed as x′=ax. The low-complexity scaling filter may have a shape of 1×1. Filtering using the low-complexity scaling filter may omit operations other than scaling. In implementations wherein the low-complexity filter is a low-complexity scaling filter, accessing the low-complexity filtering data includes accessing low-complexity filtering scaling factor data indicating the scaling factor.

In some implementations, accessing the scaling factor includes accessing a low-complexity filtering scaling factor index value that indicates a non-uniform quantization of the low-complexity filtering scaling factor. For example, a low-complexity filtering scaling factor index value of zero (0) may indicate a low-complexity filtering scaling factor of 2/8, a low-complexity filtering scaling factor index value of one (1) may indicate a low-complexity filtering scaling factor of 4/8, a low-complexity filtering scaling factor index value of two (2) may indicate a low-complexity filtering scaling factor of 6/8, and a low-complexity filtering scaling factor index value of three (3) may indicate a low-complexity filtering scaling factor of 7/8.

In some implementations, the low-complexity filter is a linear filter (low-complexity linear filter), wherein a respective sample (x) is multiplied by a corresponding scaling factor (a) and combined, such as by addition, with a corresponding offset value (b), to obtain a filtered sample value (x′), which may be expressed as x′=ax+b. Filtering using the low-complexity linear filter may omit non-linear operations, such as clipping. In implementations wherein the low-complexity filter is a low-complexity linear filter, accessing the low-complexity filtering data includes accessing low-complexity filtering scaling factor data indicating the scaling factor and accessing low-complexity filtering offset data indicating the offset value.

In some implementations, the low-complexity filter is a combination of a linear filter and a non-linear operation, wherein a respective sample (x) is multiplied by a corresponding scaling factor (a) and combined, such as by addition, with a corresponding offset value (b), to obtain an unconstrained filtered sample value, and the unconstrained filtered sample value is clipped, or constrained, using the non-linear operation to be within a defined range, such as a from a minimum value (inclusive) to a maximum value (inclusive).

In implementations wherein the low-complexity filter includes the combination of the linear filter and the non-linear operation, accessing the low-complexity filtering data includes accessing low-complexity filtering scaling factor data indicating the scaling factor, accessing low-complexity filtering offset data indicating the offset value, accessing low-complexity filtering clipping minimum data indicating the minimum value of the range, and accessing low-complexity filtering clipping maximum data indicating the maximum value of the range.

In some implementations, the scaling factor may be zero and obtaining filtered reconstructed block data 1000 may be otherwise skipped, omitted, or excluded.

In some implementations, accessing the low-complexity filtering data from the encoded bitstream includes accessing the low-complexity filtering data from frame level data for the current frame.

In some implementations, accessing the low-complexity filtering data from the encoded bitstream includes accessing the low-complexity filtering data from slice level data for a slice of the current frame, such as a slice that includes the current block. In some implementations, the low-complexity filtering data may be accessed from slice level data for a slice of the current frame other than the slice that includes the current block.

In some implementations, accessing the low-complexity filtering data from the encoded bitstream includes accessing the low-complexity filtering data from tile level data for a tile of the current frame, such as a tile that includes the current block. In some implementations, the low-complexity filtering data may be accessed from tile level data for a tile of the current frame other than the tile that includes the current block.

In some implementations, accessing the low-complexity filtering data from the encoded bitstream includes accessing the low-complexity filtering data from group-of-blocks level data, or superblock data, such as for a group of blocks, or a superblock, which includes the current block.

In some implementations, accessing the low-complexity filtering data from the encoded bitstream includes accessing the low-complexity filtering data from block level data or coding tree unit level data.

In some implementations, accessing the low-complexity filtering data from the encoded bitstream includes accessing the low-complexity filtering data from coding tree block level data or data for a component, such as a luma component or a chroma component, of the current block.

Accessing the low-complexity filtering data from the encoded bitstream (at 1030) includes accessing one or more of the low-complexity filtering scaling factor data, the low-complexity filtering offset data, the low-complexity filtering clipping minimum data, or the low-complexity filtering clipping maximum data from the encoded bitstream.

In some implementations, the low-complexity filter is the low-complexity scaling filter and accessing the low-complexity filtering data from the encoded bitstream includes accessing the low-complexity filtering scaling factor data, such as a low-complexity filtering scaling factor index value, indicating the scaling factor from the low-complexity filtering data from the encoded bitstream.

In some implementations, the low-complexity filter is the low-complexity linear filter and accessing the low-complexity filtering data from the encoded bitstream includes accessing the low-complexity filtering scaling factor data, such as a low-complexity filtering scaling factor index value, indicating the scaling factor from the low-complexity filtering data from the encoded bitstream and accessing the low-complexity filtering offset data indicating the offset value from the low-complexity filtering data from the encoded bitstream.

In some implementations, the low-complexity filter is a combination of the low-complexity linear filter and a non-linear operation and accessing the low-complexity filtering data from the encoded bitstream includes accessing the low-complexity filtering scaling factor data, such as the low-complexity filtering scaling factor index value, indicating the scaling factor from the low-complexity filtering data from the encoded bitstream, accessing the low-complexity filtering offset data indicating the offset value from the low-complexity filtering data from the encoded bitstream, accessing the low-complexity filtering clipping minimum data indicating the minimum value of the range from the low-complexity filtering data from the encoded bitstream, and accessing the low-complexity filtering clipping maximum data indicating the maximum value of the range from the low-complexity filtering data from the encoded bitstream.

In some implementations, accessing the low-complexity filtering data from the encoded bitstream includes accessing, from coding tree block level data for a current luma coding tree block of the current block, low-complexity filtering flag data for the current luma coding tree block indicating whether low-complexity filtering is enabled, or disabled, for the current luma coding tree block. In some implementations, decoding includes determining whether low-complexity filtering is enabled, or disabled, for the current luma coding tree block in accordance with the low-complexity filtering flag data.

In some implementations, accessing the low-complexity filtering flag data for the current luma coding tree block from the coding tree block level data for the current luma coding tree block includes entropy decoding the low-complexity filtering flag data using an entropy coding context obtained in accordance with low-complexity filtering flag data for a luma coding tree block above the current luma coding tree block, low-complexity filtering flag data for a luma coding tree block to the left of the current luma coding tree block, or a combination of the low-complexity filtering flag data for the luma coding tree block above the current luma coding tree block and the low-complexity filtering flag data for the luma coding tree block to the left of the current luma coding tree block.

In some implementations, the low-complexity filtering flag data for the current luma coding tree block indicates that low-complexity filtering is enabled for the current luma coding tree block, and accessing the low-complexity filtering data from the encoded bitstream includes accessing the low-complexity filtering scaling factor data for the current luma coding tree block from the encoded bitstream. For example, in response to determining that the low-complexity filtering flag data for the current luma coding tree block indicates that low-complexity filtering is enabled for the current luma coding tree block, decoding includes accessing low-complexity filtering scaling factor data for the current luma coding tree block from the encoded bitstream.

In some implementations, accessing the low-complexity filtering scaling factor data for the current luma coding tree block from the encoded bitstream includes accessing the low-complexity filtering scaling factor data from the encoded bitstream using fixed length coding, truncated unary coding, or truncated binary coding.

The second filtered reconstructed block data is obtained (at 1040) by filtering the first filtered reconstructed block data using the low-complexity filter.

In some implementations, obtaining the first filtered reconstructed block data (at 1010) includes sample adaptive offset (SAO) filtering the reconstructed block data to obtain sample adaptive offset filtered reconstructed block data and obtaining the first filtered reconstructed block data by filtering the sample adaptive offset filtered reconstructed block data using the first filter.

Obtaining filtered reconstructed block data 1000 omits, skips, avoids, or excludes filtering the sample adaptive offset filtered reconstructed block data using the low-complexity filter prior to filtering the sample adaptive offset filtered reconstructed block data using the first filter.

In some implementations, the first filter is a component of adaptive loop filtering (ALF). Adaptive loop filtering may be used, or applied, to filter the sample adaptive offset filtered reconstructed block data.

In some implementations, the first filter is an artificial neural network filter, or artificial neural network loop filter, trained on training data that omits, skips, avoids, or excludes the current frame (offline trained). In some implementations, parameter data for the artificial neural network filter is omitted, absent, or unavailable from the portion of the encoded bitstream corresponding to the current frame. In some implementations, filtering using the artificial neural network filter, or artificial neural network loop filter, as the first filter is omitted, skipped, avoided, or excluded.

The filtered reconstructed block data is obtained (at 1050).

In some implementations, obtaining the filtered reconstructed block data (at 1050) includes using the second filtered reconstructed block data (obtained at 1040) as the filtered reconstructed block data.

In an example, the reconstructed block data is filtered using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain the first filtered reconstructed block data (at 1020), wherein the adaptive loop filtering omits filtering using an adaptive filter. The first filtered reconstructed block data is filtered using the low-complexity filter to obtain the second filtered reconstructed block data (at 1040). The second filtered reconstructed block data is used as the filtered reconstructed block data (at 1050).

In some implementations, obtaining the filtered reconstructed block data (at 1050) includes filtering the second filtered reconstructed block data (obtained at 1040) to obtain the filtered reconstructed block data.

In an example, the reconstructed block data is filtered using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain the first filtered reconstructed block data (at 1020). The first filtered reconstructed block data is filtered using the low-complexity filter to obtain the second filtered reconstructed block data (at 1040). The second filtered reconstructed block data is filtered (at 1050) using an adaptive filter of adaptive loop filtering wherein parameters of the adaptive filter are signaled, or included, in, and accessed from, the encoded bitstream, or in the portion of the encoded bitstream corresponding to the current frame, to obtain the filtered reconstructed block data.

In an example, the reconstructed block data is filtered using an artificial neural network loop filter, trained on training data that omits, skips, avoids, or excludes the current frame (offline trained), wherein parameters of the artificial neural network loop filter are omitted, excluded, or otherwise absent, from the encoded bitstream, or from the portion of the encoded bitstream corresponding to the current frame, to obtain the first filtered reconstructed block data (at 1020). The first filtered reconstructed block data is filtered using the low-complexity filter to obtain the second filtered reconstructed block data (at 1040). The second filtered reconstructed block data is filtered (at 1050) using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using an adaptive filter wherein parameters of the adaptive filter are signaled, or included, in, and accessed from, the encoded bitstream, or in the portion of the encoded bitstream corresponding to the current frame, to obtain the filtered reconstructed block data.

In an example, the reconstructed block data is filtered using an artificial neural network loop filter, trained on training data that omits, skips, avoids, or excludes the current frame (offline trained), wherein parameters of the artificial neural network loop filter are omitted, excluded, or otherwise absent, from the encoded bitstream, or from the portion of the encoded bitstream corresponding to the current frame, to obtain the first filtered reconstructed block data (at 1020). The first filtered reconstructed block data is filtered using the low-complexity filter to obtain the second filtered reconstructed block data (at 1040). The second filtered reconstructed block data is filtered (at 1050) using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain third filtered reconstructed block data. The third filtered reconstructed block data is filtered using an adaptive filter of adaptive loop filtering wherein parameters of the adaptive filter are signaled, or included, in, and accessed from, the encoded bitstream, or in the portion of the encoded bitstream corresponding to the current frame, to obtain the filtered reconstructed block data.

In an example, the reconstructed block data is filtered using an artificial neural network loop filter, trained on training data that omits, skips, avoids, or excludes the current frame (offline trained), wherein parameters of the artificial neural network loop filter are omitted, excluded, or otherwise absent, from the encoded bitstream, or from the portion of the encoded bitstream corresponding to the current frame, to obtain the first filtered reconstructed block data (at 1020). The first filtered reconstructed block data is filtered using the low-complexity filter to obtain the second filtered reconstructed block data (at 1040). The second filtered reconstructed block data is filtered (at 1050) using sample adaptive offset filtering to obtain sample adaptive offset filtered reconstructed block data. The sample adaptive offset filtered reconstructed block data is filtered using adaptive loop filtering wherein the adaptive loop filtering includes filtering the sample adaptive offset filtered reconstructed block data using a fixed, or offline trained, filter as the first filter, wherein parameters of the fixed, or offline trained, filter are omitted, excluded, or otherwise absent, from the encoded bitstream, or from the portion of the encoded bitstream corresponding to the current frame, to obtain third filtered reconstructed block data. The third filtered reconstructed block data is filtered using the low-complexity filter to obtain fourth filtered reconstructed block data. The fourth filtered reconstructed block data is filtered (at 1050) using an adaptive filter of adaptive loop filtering wherein parameters of the adaptive filter are signaled, or included, in, and accessed from, the encoded bitstream, or in the portion of the encoded bitstream corresponding to the current frame, to obtain the filtered reconstructed block data.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
obtaining reconstructed block data for a current block of a current frame by decoding encoded block data from an encoded bitstream;
obtaining filtered reconstructed block data for the current block, wherein obtaining the filtered reconstructed block data includes:
obtaining a first filter for the current block, wherein obtaining the first filter omits accessing parameter data for the first filter from a portion of the encoded bitstream corresponding to the current frame;
obtaining first filtered reconstructed block data for the current block by filtering the reconstructed block data using the first filter;
accessing, from the portion of the encoded bitstream corresponding to the current frame, low-complexity filtering data for a low-complexity filter; and
obtaining second filtered reconstructed block data for the current block by filtering the first filtered reconstructed block data using the low-complexity filter; and
outputting the filtered reconstructed block data.

2. The method of claim 1, wherein accessing the low-complexity filtering data includes:
accessing the low-complexity filtering data from frame level data;
accessing the low-complexity filtering data from slice level data;
accessing the low-complexity filtering data from tile level data;
accessing the low-complexity filtering data from group-of-blocks level data;
accessing the low-complexity filtering data from block level data; or
accessing the low-complexity filtering data from coding tree block level data.

3. The method of claim 1, wherein accessing the low-complexity filtering data includes:
accessing one or more of low-complexity filtering scaling factor data, low-complexity filtering offset data, low-complexity filtering clipping minimum data, or low-complexity filtering clipping maximum data.

4. The method of claim 1, wherein accessing the low-complexity filtering data includes:
accessing low-complexity filtering scaling factor data.

5. The method of claim 1, wherein accessing the low-complexity filtering data includes:
accessing low-complexity filtering scaling factor data and low-complexity filtering offset data.

6. The method of claim 1, wherein accessing the low-complexity filtering data includes:
accessing low-complexity filtering scaling factor data, low-complexity filtering offset data, low-complexity filtering clipping minimum data, and low-complexity filtering clipping maximum data.

7. The method of claim 1, wherein accessing the low-complexity filtering data includes:
accessing the low-complexity filtering data from coding tree block level data for a current luma coding tree block of the current block, wherein the low-complexity filtering data includes low-complexity filtering flag data for the current luma coding tree block indicating whether low-complexity filtering is enabled for the current luma coding tree block.

8. The method of claim 7, wherein accessing the low-complexity filtering data includes:
entropy decoding the low-complexity filtering flag data for the current luma coding tree block using an entropy coding context obtained in accordance with low-complexity filtering flag data for a luma coding tree block above the current luma coding tree block, low-complexity filtering flag data for a luma coding tree block to the left of the current luma coding tree block, or a combination of the low-complexity filtering flag data for the luma coding tree block above the current luma coding tree block and the low-complexity filtering flag data for the luma coding tree block to the left of the current luma coding tree block.

9. The method of claim 7, wherein accessing the low-complexity filtering data includes:
in response to determining that the low-complexity filtering flag data for the current luma coding tree block indicates that low-complexity filtering is enabled for the current luma coding tree block, accessing low-complexity filtering scaling factor data for the current luma coding tree block from the encoded bitstream.

10. The method of claim 9, wherein accessing the low-complexity filtering scaling factor data includes:
accessing the low-complexity filtering scaling factor data from the encoded bitstream using fixed length coding, truncated unary coding, or truncated binary coding.

11. The method of claim 9, wherein accessing the low-complexity filtering scaling factor data includes:
accessing, from the encoded bitstream, a low-complexity filtering scaling factor index value that indicates a non-uniform quantization of a low-complexity filtering scaling factor.

12. The method of claim 1, wherein accessing the low-complexity filtering data includes:
accessing the low-complexity filtering data for a current chroma coding tree block of the current block from slice level data for a slice of the current frame.

13. The method of claim 1, wherein:
the first filter is an artificial neural network filter trained on frames other than the current frame.

14. The method of claim 1, wherein obtaining the filtered reconstructed block data includes:
using the second filtered reconstructed block data as the filtered reconstructed block data.

15. The method of claim 1, wherein obtaining the filtered reconstructed block data includes:
obtaining a second filter for the current block, wherein obtaining the second filter includes accessing parameter data for the second filter from a portion of the encoded bitstream corresponding to the current frame; and
obtaining the filtered reconstructed block data by filtering the second filtered reconstructed block data for the current block using the second filter.

16. The method of claim 1, wherein obtaining the first filter includes accessing parameter data for the first filter from a portion of the encoded bitstream corresponding to a frame other than the current frame.

17. A non-transitory computer-readable storage medium, having stored thereon an encoded bitstream comprising:
encoded block data for a current block of a current frame; and
low-complexity filtering data for a low-complexity filter for filtering filtered reconstructed block data for the current block, wherein the filtered reconstructed block data corresponds to filtering, using a first filter, reconstructed block data for the current block, wherein the reconstructed block data corresponds to decoding the encoded block data, wherein parameter data for the first filter is absent from a portion of the encoded bitstream corresponding to the current frame.

18. The non-transitory computer-readable storage medium of claim 17, wherein the encoded bitstream includes:
frame level data including the low-complexity filtering data;
slice level data including the low-complexity filtering data;
tile level data including the low-complexity filtering data;
group-of-blocks level data including the low-complexity filtering data;
block level data including the low-complexity filtering data; or
coding tree block level data including the low-complexity filtering data.

19. The non-transitory computer-readable storage medium of claim 17, wherein the low-complexity filtering data includes:
one or more of low-complexity filtering scaling factor data, low-complexity filtering offset data, low-complexity filtering clipping minimum data, or low-complexity filtering clipping maximum data.

20. The non-transitory computer-readable storage medium of claim 17, wherein the low-complexity filtering data includes:
low-complexity filtering scaling factor data.
